(19) United States
(12) Patent Application Publication
(10) Pub. No.: US 2004/0006288 A1
(43) Pub. Date: Jan. 8, 2004

(54) Pressure-pulse therapy device for treatment of deposits

(76) Inventors: Avner Spector, Savyon (IL); Alex Harel, Savyon (IL)

Correspondence Address: Anthony Castorina, G E Ehrlich, Suite 207, 2001 Jefferson Davis Highway, Arlington, VA, 22202, US

(21) Appl. No.: 10/415,293

(22) PCT Filed: Oct. 29, 2001
(86) PCT No.: PCT/IL01/01002

(30) Foreign Application Priority Data
Oct. 29, 2000 (IL) 139332

(51) Int. Cl. A61H 1/00

(52) U.S. Cl. 601/2

(57) ABSTRACT

A device, system and method for the generation of therapeutic acoustic shock waves for at least partially separating a deposit from a vascular structure. The shock waves may optionally be generated according to any mechanism which is known in the art, including but not limited to, spark gap technology, electromagnetic shock wave generation and piezoelectric technology for generating therapeutic pressure pulses. Examples of deposits which may be treated with the present invention include, but are not limited to, atherosclerotic plaques, any type of clot, and any type of thrombus or embolus. The vascular structure itself may be any such structure for conducting blood flow, including but not limited to arteries, veins and the aortic arch.

### FIELD OF THE PRESENT INVENTION

The present invention is of a device, system and method for pressure-pulse therapy for the treatment of deposits, and in particular to such a device, system and method for the treatment of deposits in a vascular structure, preferably through the generation of compound pressure pulses.

### BACKGROUND OF THE PRESENT INVENTION

Pressure-pulse therapy, also known as shock-wave therapy, has many uses. It is used in lithotripsy as a non-invasive technique for pulverizing kidney stones and calculi in the bladder and urethra. It is also used for dissolving lipids in cells close to the skin and in the pelvic region.

U.S. Pat. No. 4,620,545 for “Non-Invasive Destruction of Kidney Stones” to Shene et al., whose disclosure is incorporated herein by reference, describes a pressure-pulse therapy apparatus which includes an ellipsoidal reflector, having a first focal point within the reflector's dome and a second focal point outside the reflector's dome. A flexible membrane caps the reflector, and the region contained by the reflector and the membrane is filled with a liquid medium, for pulse propagation. A pressure-pulse source is located at the first focal point, within the medium. This configuration provides that a portion of a pulse originating from the source, at the first focal point, will impinge on the reflector, be reflected by it, and be brought into focus at the second focal point. The reflector is movable and can be positioned so that the second focal point coincides with a concretion within the body that is to be pulverized. A sonic aiming mechanism is used to detect the concretion and to direct the positioning of the reflector.

In general, pressure-pulse therapy is accompanied by an imaging mechanism, such as the sonic aiming mechanism of U.S. Pat. No. 4,620,545. The region for treatment is generally small, between 0.3 and 1.5 cm, and it is desirous to image the location in order for the therapy to be applied effectively. X-ray imaging may be used; however, with x-rays, the patient and the physician are exposed to radiation doses with each treatment. Furthermore, such x-ray imaging has the disadvantage of being performed through mechanisms which are completely separate from the treatment mechanism with pressure-pulse therapy, such that the overall treatment is interrupted by the x-ray imaging procedure.

Furthermore, the above methods have not been designed for the treatment of vascular blockages, such as thromboses and other types of blockages in the arteries and the veins. One of the most common medical conditions, especially in the western world, is the occlusion of arteries by atherosclerotic plaques. In such condition, the atherosclerotic plaques narrow the arterial lumen, which leads to decrease in flow and downstream pressure. Blood flow occlusion by atherosclerotic plaques is a common desease. Five percent of the population above the age of 50 is suffering from blood flow disorders in peripheral arteries (extremities).

Currently available treatments for artery occlusion include drug therapy to prevent accumulation of blocking material; catheterization, which involves the insertion of catheter with a balloon that can be inflated in the blocked area and open the blockage; the performance of stent therapy through the insertion of a stent or tiny cylinder to the blocked area to preserve an open artery; and bypass surgery to create a new blood flow at the occluded area by using another blood vessel (vein or artery taken from other part of body organ).

All the above methods do not prevent the initiation of the atherosclerotic formation. Moreover, the above methods do not separate the plaques from the artery wall. In many cases, the occlusion re-occurs after the treatment requiring repeated treatment and often bypasses surgery. In particular, bypass surgery is prolonged and expensive procedure in which the patient suffers severe pains and long recovery period.

### SUMMARY OF THE PRESENT INVENTION

The background art does not teach or suggest a device, system or method to treat blockages in the vascular system which is non-invasive yet is able to physically remove the blockage. In addition, the background art does not teach or suggest such a device, system or method which is able to at least partially separate deposits from the walls of a vascular structure but which is also non-invasive. The background art also does not teach or suggest such a device, system or method which combines precise imaging, performed in an efficient, timely manner, with the above capabilities for removing or at least partially separating deposits and/or blockages from a vascular structure.

The present invention overcomes these deficiencies of the background art by providing a device, system and method for the generation of therapeutic acoustic shock waves for at least partially separating a deposit from a vascular structure. The shock waves may optionally be generated according to any mechanism which is known in the art, including but not limited to, spark gap technology, electromagnetic shock wave generation, generation by laser and piezoelectric technology for generating therapeutic acoustic shock waves. Examples of deposits which may be treated with the present invention include, but are not limited to, atherosclerotic plaques, any type of clot, and any type of thrombus or embolus. The vascular structure itself may be any such structure for conducting blood flow, including but not limited to arteries, veins and the aortic arch.

In addition, a suitable device for producing therapeutic acoustic shock waves according to the spark gap technology is disclosed in U.S. Pat. No. 3,442,531, which is hereby incorporated by reference as if fully set forth herein. A suitable device for producing therapeutic acoustic shock waves according to electromagnetic technology is disclosed in U.S. Pat. No. 4,782,821, which is also hereby incorporated by reference as if fully set forth herein. Other examples include, but are not limited to, such devices as Orthospec™, Econolith™ and Econolith 2000™ (Medispec Ltd., Israel).

By “at least partially separating”, it is meant that the deposit may be at least partially detached, but may also (additionally or alternatively) be completely separated, dissolved or otherwise broken up or disintegrated, or otherwise removed from the vascular structure. Such separation may for example represent a disconnection between the deposit, such as a blood clot or plaque, and the vascular structure, but without causing additional severe damage to that vascular structure.

### BRIEF DESCRIPTION OF THE DRAWINGS

The present invention will be more clearly understood from the accompanying detailed description and drawings, in which same number designations are maintained throughout the figures for each element and in which:

FIG. 1 is a schematic representation of an exemplary shock wave therapy device according to the present invention;

FIG. 2 shows the device of FIG. 1 in place with a subject;

FIG. 3 shows a schematic block diagram of a portion of the device of FIG. 1 with certain exemplary distances according to the present invention;

FIG. 4 is a schematic representation of an exemplary shock wave therapy system according to the present invention;

FIG. 5 is a flowchart of an exemplary method according to the present invention;

FIG. 6 shows a picture of the phantom with an arterial piece for testing the present invention; and

FIGS. 7A and 7B show “before” and “after” pictures of the treated artery.

### DETAILED DESCRIPTION OF PREFERRED EMBODIMENTS

The present invention is of a device, system and method for the generation of therapeutic acoustic shock waves for at least partially separating a deposit from a vascular structure. The shock waves may optionally be generated according to any mechanism which is known in the art, including but not limited to, spark gap technology, electromagnetic shock wave generation, generation by laser and piezoelectric technology for generating therapeutic acoustic shock waves. Examples of deposits which may be treated with the present invention include, but are not limited to, atherosclerotic plaques, any type of clot, and any type of thrombus or embolus. The vascular structure itself may be any such structure for conducting blood flow, including but not limited to arteries, veins and the aortic arch.

According to preferred embodiments of the present invention, the device for generating shock waves is preferably combined with an imaging mechanism for the system of the present invention. The imaging mechanism is preferably not a real-time imaging device, but instead performs such imaging as a separate process. Non-real time imaging is preferred in order to permit the most efficient positioning of both the device for generating shock waves and the imaging device/mechanism at the subject. Such positioning more preferably includes such factors as optimal distance from the subject, which most preferably is a relatively short distance such as about one meter or less; and optimal geometric placement relative to both the size and shape of the emitting portion of the device for generating shock waves, and to the physical dimensions and geometric shape of the organ to be treated. These factors limit the placement of the imaging mechanism/device and of the shock wave generating device, such that non-real time imaging is preferred.

However, more preferably, when combined in a single system, the separation of the imaging and treatment processes does not result in a significant delay of treatment. Also more preferably, the use of such imaging enables the shock waves to be targeted to the area of the body to be treated, most preferably through an automatic targeting process.

Examples of suitable imaging mechanisms include but are not limited to, an x-ray mechanism, preferably with contrast media such as for angiography; ultrasound and preferably ultrasound doppler; MRI (magnetic resonance imaging) and CT (computerized tomography).

A description of ultrasound doppler imaging may be found at http://www.vh.org/Providers/Lectures/IROCH/IowaRadOnCallHandbook.html as of Aug. 3, 2001 which is hereby incorporated by reference as if fully set forth herein. Briefly, the transducer in such a device emits acoustic pulses which reflect from cells in the flowing blood. The Doppler shift from the blood cells enables the velocity of the blood to be measured, which when multiplied by the cross-sectional area of a blood vessel, provides the rate of flow in that blood vessel in mm/unit time. In a vascular structure without an occlusion (deposit), a clear linear uninterrupted flow is seen; the presence of a deposit and particularly a blockage alters this flow. The alteration depends upon the nature and severity of the deposit or blockage.

The principles and operation of a device, a system and a method according to the present invention may be better understood with reference to the drawings and the accompanying description, it being understood that these drawings are given for illustrative purposes only and are not meant to be limiting.

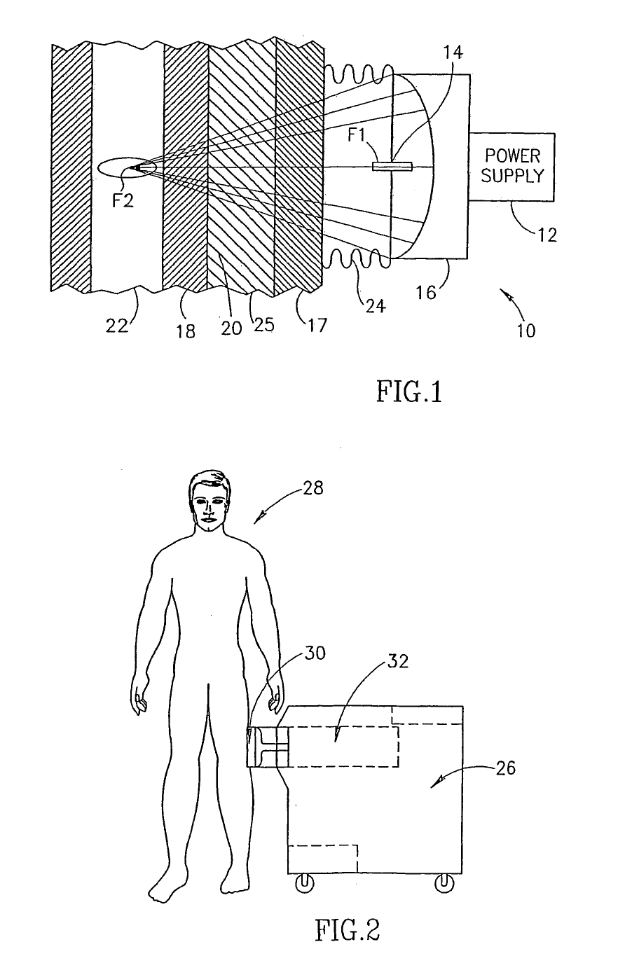

Referring now to the drawings, FIG. 1 is a schematic block diagram of an illustrative, exemplary device according to the present invention for generating therapeutic acoustic shock waves. As shown, a device 10 features a high voltage pulse generator 12, as is known in the art (for example with regard to U.S. Pat. No. 3,442,531, previously incorporated by reference). Pulse generator 12 generates an electrical pulse, which is transmitted to a spark gap 14. Spark gap 14 is immersed in liquid, such that the electrical pulse creates plasma, which in turn causes an acoustic shock wave to be produced. The shock wave expands radially from spark gap 14 until this wave strikes a concave reflector 16, which is optionally and preferably an ellipsoid. Alternatively, concave reflector 16 may optionally have any geometric shape with similar focal properties.

Concave reflector 16 focuses the shock wave generated at a focal point F1, and reflects the shock wave to focal point F2 (the second focus of the ellipse) at a portion of the body of the patient, shown as a structure 18. Structure 18 is a vascular structure, featuring an outer wall 20 and an inner portion 22 for carrying blood, but is intended as a non-limiting example of such a vascular structure. For the purposes of this example, focal point F2 is shown at a particular part of inner portion 22, for example for at least partially separating a deposit from inner portion 22 (not shown).

Commonly, in order to prevent leakage of fluids, a flexible membrane 24 is preferably used to cover spark gap 14 and concave reflector 16. The volume between spark gap 14 and concave reflector 16 is then preferably filled with a liquid or other material, such as water for example, in order to provide acoustic coupling. An acoustic coupling material 17 is preferably located between flexible membrane 24 and layers 25 of body tissue, such as skin for example, at the subject to which the shock waves are being directed (not shown), in order to provide acoustic coupling, which is the uniform coupling of acoustic waves from concave reflector 16 to the surface of the subject to which the shock waves are being directed. Acoustic coupling mechanism 17 may optionally be a gel, for example.

FIG. 2 shows an exemplary container 26 for containing the device of FIG. 1 (not shown). Container 26 is positioned against a portion of a patient (subject) 28 in order to deliver the shock waves by a shock wave reflector 30. Container 26 also preferably features a control panel 32 for controlling the operation of the device of FIG. 1.

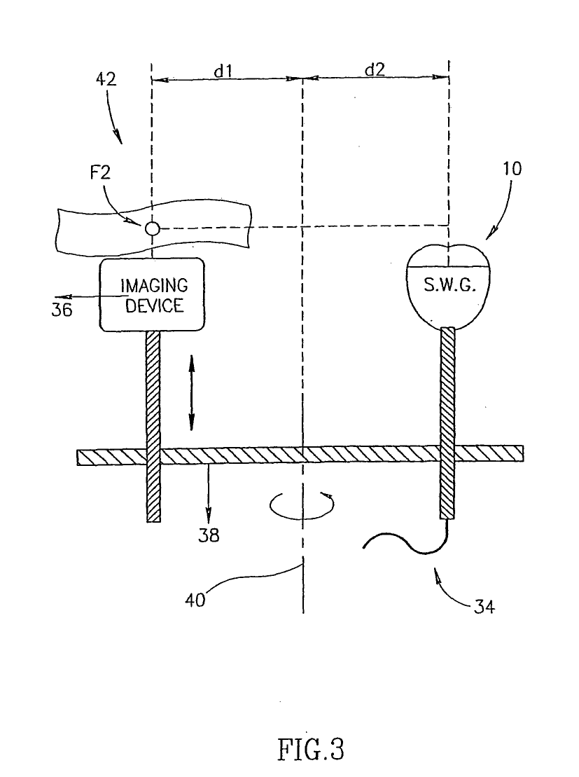

FIG. 3 shows a schematic block diagram of a portion of an exemplary system according to the present invention for combining an imaging mechanism with the device of FIG. 1 for more precise targeting of the shock waves to the patient. As shown, a system 34 again features device 10 of FIG. 1, or alternatively any other type of suitable shock wave generating device as previously described. An imaging device 36 is shown, for generating images of the area to be treated. For this example, imaging device 36 is preferably an ultrasound device and is more preferably an ultrasound doppler device.

Both imaging device 36 and device 10 are preferably positioned on a joint axis 38, which is optionally an actual mechanical device, but which alternatively is a “virtual axis”, in the sense that imaging device 36 and device 10 are located coaxially but are not directly physically connected. Each of imaging device 36 and device 10 is also preferably located a distance “d1” or “d2”, respectively (see labeled arrows) from a rotation axis 40. Again, rotation axis 40 is optionally an actual mechanical device, but alternatively is a “virtual axis”, as previously described. Preferably, system 34 can be moved in all three dimensions (along the x,y and z axes).

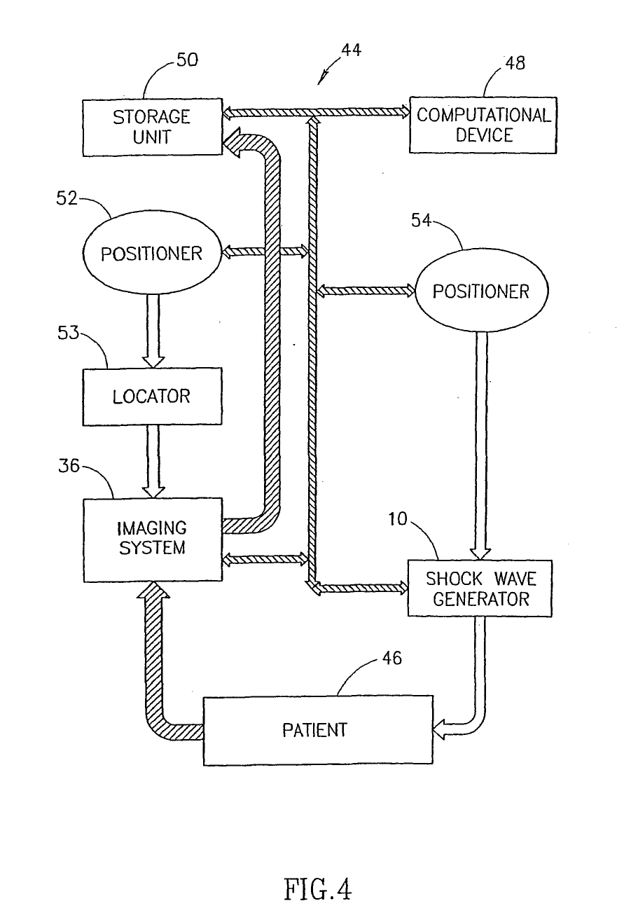

For the operation of system 34, imaging device 36 is preferably used to determine the location of the area to be treated, such as an area of the vascular system which contains a deposit (not shown). Imaging device 36 may optionally be used as part of an automatic targeting system, as described in greater detail below with regard to FIG. 4. For this example, imaging device 36 may be used for manual or automatic targeting of the pressure pulses. Once the focal area has been located on the body of the patient, device 10 is aimed to the proper area. Preferably, device 10 and imaging device 36 are located on the same radius, so that once a treatment area 42 (labeled as “F2”) has been located, the location of system 34 is preferably adjusted to position the second focal point, which is the focal point of the shock waves themselves, at treatment area 42.

The shock waves then cause at least partial separation of a deposit from a vascular structure of the patient, since the deposit has different acoustical properties than the surrounding vascular and other tissues of the patient. Therefore, the energy of the shock waves is preferentially transferred to the deposit, which may for example cause disintegration of the deposit, but preferably causes the deposit to become at least partially separated from the surrounding tissues. As described in greater detail below, the deposit may then optionally at least be manually removed (for example through surgery, which may optionally be minimally invasive surgery). Alternatively or additionally, also as described in greater detail below, the deposit may be removed or at least reduced through combined therapy with a known therapeutic modality, such as treatment with anti-coagulative drugs for example, or alternatively or additionally, with a catheter or other non-invasive treatment. Any of these additional treatments may optionally be known as a block removal mechanism, whether as a catheter or drug treatment, for example.

FIG. 4 is a schematic block diagram of an illustrative system 44 according to the present invention, which is another preferred embodiment of such a system. System 44 again features device 10 of FIG. 1, or alternatively any other type of suitable shock wave generating device as previously described. Also, imaging device 36 is again shown, for generating images of the area to be treated. For this example, imaging device 36 is again preferably an ultrasound device and is more preferably an ultrasound doppler device.

Imaging device 36 gathers at least one and preferably a plurality of images of the area of a patient 46 to be treated. As imaging device 36 is more preferably an ultrasound doppler device, both ultrasound and doppler images are more preferably collected. The ultrasound image shows the static structure of the portion of the vascular system, while the doppler image shows detected movement, such as the flow of blood through that structure. In combination, the area of the deposit may be more precisely determined.

For performing such a determination, the collected data is preferably fed to a computational device 48. The collected data may also optionally, alternatively or additionally, be stored in a storage unit 50. Computational device 48 preferably then analyzes the collected imaging data to locate the deposit. Such a deposit may optionally be located automatically; alternatively, a human operator may also at least partially perform a manual determination of the location of the deposit.

More preferably, computational device 48 also receives information about the relative location of imaging device 36 from a positioner 52, which precisely determines the location of imaging device 36, most preferably in three dimensions. A similar positioner 54 is then used for determining the position of device 10, again most preferably in three dimensions. Alternatively, the position of each of device 10 and imaging device 36 may be otherwise known. In any case, positioner 52 and positioner 54 optionally and more preferably also position imaging device 36 and device 10 in the correct positions for performing the method of the present invention, before the operation of each such device.

The coordinates of imaging device 36 are more preferably incorporated in the analysis of the obtained image(s) from imaging device 36 by computational device 48, in order to locate the precise area to be treated. The image(s) are preferably analyzed by first locating the area to be treated on one or more images by computational device 48, and more preferably also by a locator 53, which is in communication with computational device 48 for locating the area to be treated. Next, the coordinates from the image are optionally translated into coordinates for positioning device 10, although alternatively the correct coordinates for device 10 are known mechanically, through the relative positions of each of imaging device 36 and device 10 within system 44.

Computational device 48 more preferably then positions device 10 automatically through positioner 54; alternatively, such positioning may be performed manually by a human operator. The human operator may additionally confirm the automatic placement by positioner 54. Correct positioning of device 10 enables the focal point of the shock waves to be located at the deposit to be treated.

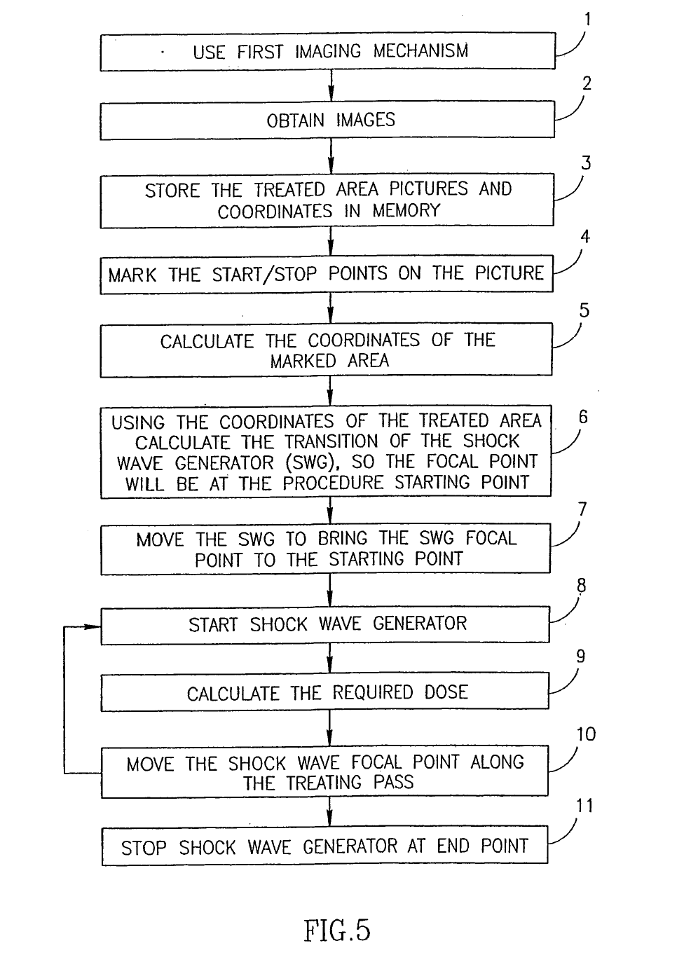

FIG. 5 shows a flowchart of an exemplary method according to the present invention. As shown in FIG. 5, in stage 1, optionally a first imaging mechanism (or other type of data) is used to provide an initial indication of the area to be treated. An example of such a mechanism is angiography. Angiography may be used to initially locate a deposit, for example to select an initial area on which the imaging process is then preferably performed.

In stage 2, the imaging mechanism is used to obtain images of that area. The imaging mechanism itself is preferably not real time, although the time gap between obtaining images and performing the treatment may optionally be very short, on the order of minutes or even seconds, if desired. For example, the imaging mechanism could optionally be an ultrasound doppler probe, while the area to be treated may optionally be a blocked vascular structure, such as an artery.

In stage 3, the pictures and coordinates for these images are preferably stored in memory. In stage 4, the precise area to be treated is optionally marked within the images, either manually (by a human operator) or preferably automatically. In stage 5, the coordinates (location) of the marked area are determined. These coordinates are used in stage 6 to aim the shock waves to a focal point which coincides with the area to be treated, preferably as described with regard to FIG. 4 above.

In stage 7, the shock wave generating device is moved, automatically, semi-automatically or manually (as previously described), in order for the focal point to be at the location determined in stage 6. In stage 8, the shock wave generating device is initialized, preferably as for normal operation of the device. In stage 9, the required dose is optionally calculated, but alternatively may be predetermined. Optionally and more preferably, in stage 10, the shock wave focal point is moved to cover an additional area of treatment. Stages 9 and 10 may optionally and preferably be repeated until at least a portion, but preferably an entirety, of the defined area from stage 5 is treated. In stage 11, the treatment is ended and the generator stops generating shock waves.

### EXAMPLE 1

### Treatment of Arteries

The present invention is useful for the treatment of deposits in any vascular structure. In order to test the efficacy of the system and method of the present invention, human arterial pieces were obtained from patients undergoing peripheral vascular by-pass surgery, and hence contained deposits; indeed, many were completely blocked. The tested pieces were obtained from peripheral blocked arteries from the legs of patients (samples 1-5) and also from a blocked aortal artery (sample 6).

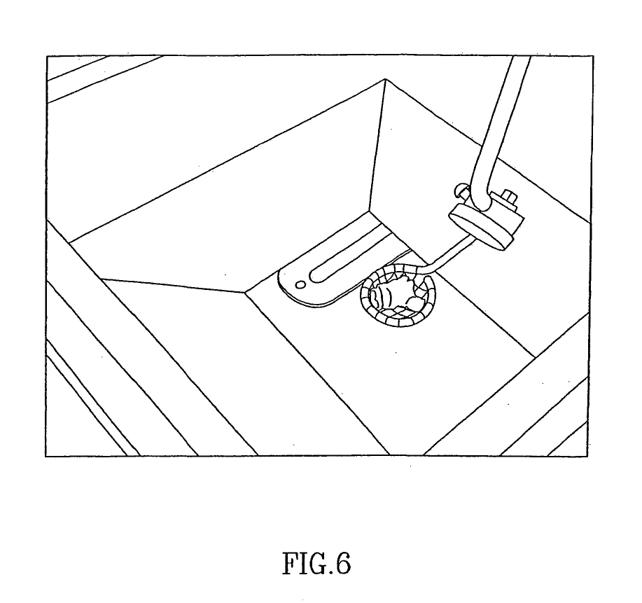

The shock wave generating device was the Echonolith 2000 (Medispec Ltd., Israel), which is a lithotripsy device having a focal area of 13 mm diameter by 58 mm length. The phantom used in the test was a plastic water container, into which each arterial piece was separately placed. A membrane for acoustic coupling was attached to one side of the container. The shock waves produced by the Echonolith 2000 were transferred from the membrane to the water, and hence passed through the arterial pieces. FIG. 6 shows a picture of the phantom with an arterial piece.

The water medium simulates the surrounding human tissue in the area to be treated, which consists of 70-90% water in any case. For treatment of an actual patient, the membrane would have been placed against the body of the patient, and the shock waves transferred in a similar manner.

The shock waves were generated according to the parameters in the following table, which include high power and frequency settings.

| Sample | Power | Frequency | number of |
|---|---|---|---|
| no. | (KV) | (pulse per minute) | pulses |
| 1 | 22.5 | 96 | 413 |
| 2 | 22.5 | 96 | 1000 |
| 3 | 22.5 | 96 | 600 |
| 4 | 22.5 | 96 | 500 |
| 5 | 22.5 | 96 | 500 |
| 6 | 22.5 | 96 | 1000 |

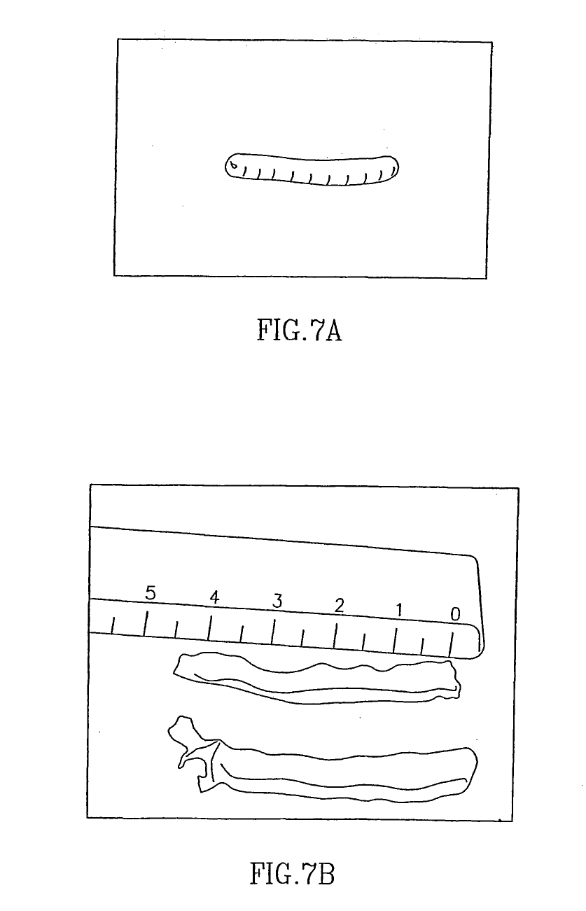

The results were as follows. After the treatment with the shock waves, the blockage inside the artery was easily separated from the artery wall and removed with forceps. The blockage was removed in one piece; no remaining material was noted on the artery wall (see FIGS. 7A and 7B for “before” and “after” pictures of the treated artery).

Additional tests were also performed on three more such samples, with 150 pulses per minute frequency and 500 pulses per unit length, to examine the effect of a higher frequency. Again, complete and easy separation between the deposit and the arterial wall was achieved.

Histological tests have shown that the operation of the method of the present invention on the above samples did not damage the arterial walls (data not shown). Furthermore, no loss of elasticity was detected. Complete removal of the clot was affected without damage to the surrounding tissue, such that restenosis may not occur.

### EXAMPLE 2

### Optional Treatment Parameters

The parameters for treatment of a deposit according to the present invention are optionally and preferably adjusted according to the type of vascular structure to be treated, location in the body of the patient, and the type and geometry of the deposit. The treatment parameters themselves are optionally and preferably defined according to pressure (energy per pulse); frequency, for which a higher frequency is preferred since the transmission of the pulses to the area to be treated may be delayed by time; and the number of pulses per length unit, which provides the dose per treatment area.

Examples of suitable but non-limiting parameters are as follows: Pressure, preferably from about 50 to about 1500 Atm, more preferably from about 500 to about 1000 Atm; Frequency, preferably from about 50 to about 500 pulses per minute, more preferably from about 100 to about 250 pulses per minute; Number of pulses per length unit, preferably from about 100 to about 5,000 per 1 cm, more preferably from about 300 to about 800 pulses per 1 cm. At the edge of the area to be treated, optionally and preferably at least about 500 pulses are applied, and more preferably less than about 1000 pulses are applied.

It will be appreciated that the above descriptions are intended only to serve as examples, and that many other embodiments are possible within the spirit and the scope of the present invention.

What is claimed is:

1. A system for treating at least a portion of a vascular structure of a subject, comprising:
(a) a shock wave generator for generating a shock wave for treating the portion of the vascular structure; and
(b) an imaging device for generating at least one image of the portion of the vascular structure to be treated, such that said shock wave is focused on the portion of the vascular structure according to a location determined from said at least one image.

2. The system of claim 1, further comprising:
(c) a locator module for determining a location of the portion according to said at least one image.

3. The system of claim 2, wherein said locator module is operated by a computational device for determining coordinates of said location of the portion.

4. The system of any of claims 1-3, wherein said imaging device operates at least partially according to at least one of x-ray imaging, MRI (magnetic resonance imaging) and CT (computerized tomography).

5. The system of any of claims 1-3, wherein said imaging device operates at least partially according to ultrasound.

6. The system of claim 5, wherein said imaging device operates at least partially according to ultrasound doppler.

7. The system of any of claims 1-3, wherein said imaging device is a non-real time imaging mechanism.

8. The system of claim 7, wherein said non-real time imaging mechanism is selected according to at least one of optimal distance from the subject and optimal geometric placement of said imaging device.

9. The system of claim 8, wherein said non-real time imaging mechanism is selected to prevent a significant delay between obtaining said at least one image and generating said shock wave.

10. The system of any of claims 2-9, further comprising:
(d) a positioner for positioning at least said shock wave generator according to said location of the portion as determined from said at least one image.

11. The system of claim 10, wherein said positioner automatically positions said shock wave generator.

12. The system of any of claims 1-11, further comprising:
(e) an initial imaging mechanism for at least initially determining an initial location of the portion.

13. The system of claim 12, wherein said initial imaging mechanism is angiography.

14. The system of claims 12 or 13, wherein said system features a positioner for positioning said imaging device according to said initial location of the portion.

15. The system of any of claims 1-14, wherein the portion of the vascular structure includes a deposit.

16. The system of claim 15, wherein said shock wave causes said deposit to become at least partially separated from the portion of the vascular structure.

17. The system of claims 15 or 16, wherein said deposit is one of a clot, thrombus and plaque.

18. The system of any of claims 1-17, wherein said shock wave is generated according to at least one of spark gap technology, piezo electric generation, generation by laser and electromagnetic generation.

19. A method for treating at least a portion of a vascular structure of a subject, comprising:
obtaining an image of the portion of the vascular structure;
determining an area of the portion of the vascular structure from said image;
focusing a shock wave on said area; and
treating at least a part of said area with said shock wave.

20. A method for treating at least a portion of a vascular structure of a subject, comprising:
determining an area of the portion of the vascular structure;
focusing a shock wave on said area; and
treating at least a part of said area with said shock wave.

21. A system for treating a tissue of a subject, comprising:
(a) a shock wave generator for generating a shock wave for treating the tissue; and
(b) an ultrasound doppler imaging device for generating at least one image of the tissue, such that said shock wave is focused on the tissue according to a location determined from said at least one image.

22. The system of claim 21, wherein said shock wave generator generates therapeutic acoustic shock waves and wherein treatment parameters are determined according to at least one of energy per pulse, frequency and number of pulses per length unit of the portion to be treated.

23. The system of claim 22, wherein energy per pulse is from about 50 to about 1500 Atm.

24. The system of claim 23, wherein energy per pulse is from about 500 to about 1000 Atm.

25. The system of any of claims 22-24, wherein frequency is from about 50 to about 500 pulses per minute.

26. The system of claim 25, wherein frequency is from about 100 to about 250 pulses per minute.

27. The system of any of claims 22-26, wherein number of pulses per length unit is from about 100 to about 5,000 per 1 cm.

28. The system of claim 27, wherein number of pulses per length unit is from about 300 to about 800 pulses per 1 cm.

29. The system of any of claims 22-28, wherein at least about 500 pulses are applied to an edge of the portion.

30. The system of claim 29, wherein less than about 1000 pulses are applied.

31. A system for treating at least a portion of a deposit on a vascular structure of a subject, comprising:
(a) a shock wave generator for generating a shock wave for treating the deposit on the portion of the vascular structure;
(b) an imaging device for generating at least one image of the portion of the vascular structure to be treated, such that said shock wave is focused on the portion of the vascular structure according to a location determined from said at least one image; and
(c) a block removal mechanism for removing the deposit after treatment by said shock wave generator.

32. The system of claim 31, wherein said block removal mechanism includes a catheter.

33. The system of claims 31 or 32, wherein said block removal mechanism includes drug treatment.

34. The system of any of claims 31-33, wherein said block removal mechanism is at least partially provided through the operation of at least one of minimal invasive surgery techniques and instruments.

35. A method for treating at least a portion of a deposit on a vascular structure of a subject, comprising:
generating at least one image of the portion of the vascular structure to be treated;
focusing said shock wave on the portion of the vascular structure according to a location determined from said at least one image;
generating a shock wave for treating the deposit on the portion of the vascular structure; and
removing the deposit after treatment by said shock wave generator.
